(19) United States
(12) Patent Application Publication
(10) Pub. No.: US 2008/0127173 A1
(43) Pub. Date: May 29, 2008

(54) Systems and methods for performing computer diagnostics

(76) Inventors: Thomas Tripp, El Dorado Hills, CA (US); Rajpal Gill, Rocklin, CA (US); Karamadai Srinivasar, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/582,695

(22) Filed: Oct. 18, 2006

(51) Int. Cl. G06F 9/445

(52) U.S. Cl. 717/174

(57) ABSTRACT

Systems and methods for performing computer diagnostics are provided. In this regard, a representative method includes: using a browser of the target machine to communicate with a server; downloading executable instructions to the target machine from the server; analyzing the target machine using the executable instructions; and automatically uninstalling, by the target machine, the executable instructions from the target machine responsive to determining that communication with the server via the browser has changed state.

### DESCRIPTION OF THE RELATED ART

Software stored on a computer is oftentimes referred to as an “image.” In a network environment, such images typically are controlled by IT departments that ensure that the images of various distributed computers of the network remain intact. However, problems do occur on such systems, such as damaged hardware, corrupted files, external software attacks, and/or registry corruption, that require the use of various diagnostic tools, i.e., software, for analyzing and correcting those problems. Unfortunately, use of diagnostic tools changes the stored image and can create challenges.

In this regard, alteration of an image can require requalification of the image that involves extensive analysis by IT department personnel. Therefore, there is a general reluctance to alter an image, even when a problem with the computer is identified. Additionally, some users that do not have IT departments come directly to OEM's for support. In this regard, some OEM's make image changes in order to diagnose and/or repair problems. However, many users perceive these changed images as a potential vulnerability, in that the ability of the OEM to perform diagnostics may enable others to access the computer.

### SUMMARY

In this regard, systems and methods for performing computer diagnostics are provided. An exemplary embodiment of such a system comprises a server operative to provide access to content via a browser of a target machine, the content comprising software to enable analyzing of the target machine, the software being configured for automatic uninstallation from the target machine such that the software causes the target machine to delete the software from the target machine.

Another exemplary embodiment of such a system comprises a target machine having a browser and executable instructions. The browser is operative to communicate with a server and the executable instructions are configured to analyze the target machine. The target machine automatically uninstalls the executable instructions responsive to determining that communication with the server via the browser has changed state.

An exemplary embodiment of such a method for performing computer diagnostics of a target machine comprises: providing access to a server, the server being accessible via a browser of the target machine; and providing, from the server to the target machine, software to enable analyzing of the target machine, the software being configured for automatic uninstallation from the target machine such that the software causes the target machine to delete the software from the target machine after use.

Another exemplary embodiment of such a method comprises: using a browser of the target machine to communicate with a server; downloading executable instructions to the target machine from the server; analyzing the target machine using the executable instructions; and automatically uninstalling, by the target machine, the executable instructions from the target machine responsive to determining that communication with the server via the browser has changed state.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram of an embodiment of a system for performing computer diagnostics.

FIG. 2 is a flowchart depicting functionality of an embodiment of a method for performing computer diagnostics.

FIG. 3 is a schematic diagram depicting another embodiment of a system for performing computer diagnostics.

FIG. 4 is a flowchart depicting functionality of an embodiment of a system for performing computer diagnostics, such as the embodiment depicted in FIG. 3.

FIG. 5 is a schematic diagram depicting the embodiment of the system of FIG. 3 after content has been downloaded from a server to the target machine.

### DETAILED DESCRIPTION

In this regard, systems and methods for performing computer diagnostics are provided, which, in some embodiments, do not require preinstallation of a software agent. Specifically, some embodiments involve the use of server-maintained diagnostic applications that can be installed upon a target machine when needed, with the diagnostic applications being completely removed from the target machine when analysis of the target machine is complete.

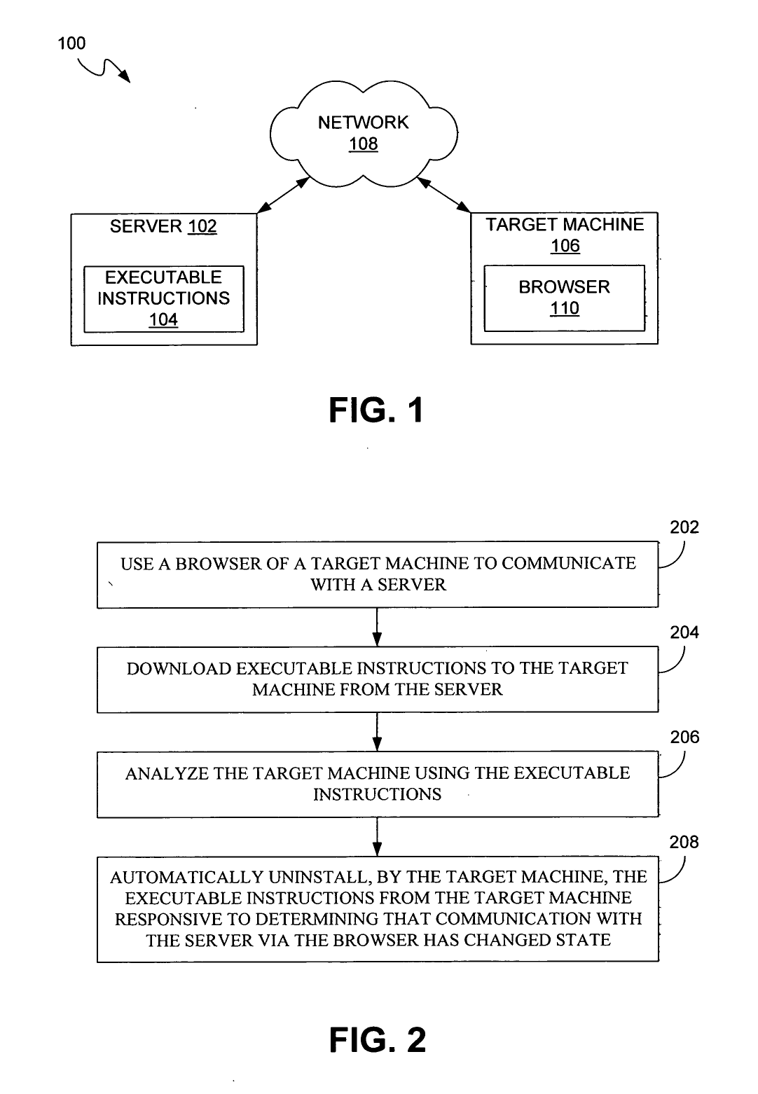

In this regard, reference is made to FIG. 1, which schematically depicts an embodiment of a system for performing computer diagnostics. As shown in FIG. 1, system 100 incorporates a server 102 that includes executable instructions 104 associated with analysis of a target machine. The server communicates with such a target machine, e.g., machine 106, via a communications network 108. In this regard, communications network 108 can include one or more various network types of networks including a wide area network (WAN), a local area network (LAN) and the Internet.

Target machine 106 incorporates a browser 110 that is used to access information, such as the executable instructions of the server. Access of the server by the browser enables the target machine to download at least some of the executable instructions maintained by the server. As will be described in greater detail later, these downloaded instructions can facilitate diagnosis of the target machine in order to determine whether and/or what corrective actions need to be taken to correct a perceived deficiency of the target machine. Following such diagnosis and/or corrective actions, the instructions downloaded to the target machine are deleted, such as via an automated process initiated by the target machine. Notably, this is in contrast to conventional diagnosis procedures that may leave instructions on the target machine.

Functionality of an embodiment of a method for performing computer diagnostics, such as may be exhibited by the embodiment of FIG. 1, is depicted in FIG. 2. As shown in FIG. 2, the process may be construed as beginning at block 202, in which a browser of a target machine is used to communicate with a server. In block 204, executable instructions are downloaded to the target machine from the server. In block 206, the target machine uses the executable instructions for analysis, i.e., to diagnose and/or correct perceived deficiencies of the target machine. Thereafter, such as depicted in block 208, the target machine automatically uninstalls the executable instructions. Specifically, in this embodiment, the instructions are automatically uninstalled responsive to determining that communication with the server via the browser has changed state. Notably, the determination of whether the state of the browser has changed is facilitated by the target machine, not by the server. It should also be noted that change of state with respect to the browser can include determining that the user of the browser has navigated to a different web page and/or that the browser has been closed. In some embodiments, manually initiated cleanup that is done remotely or initiated by the end user on the target machine can also be accommodated.

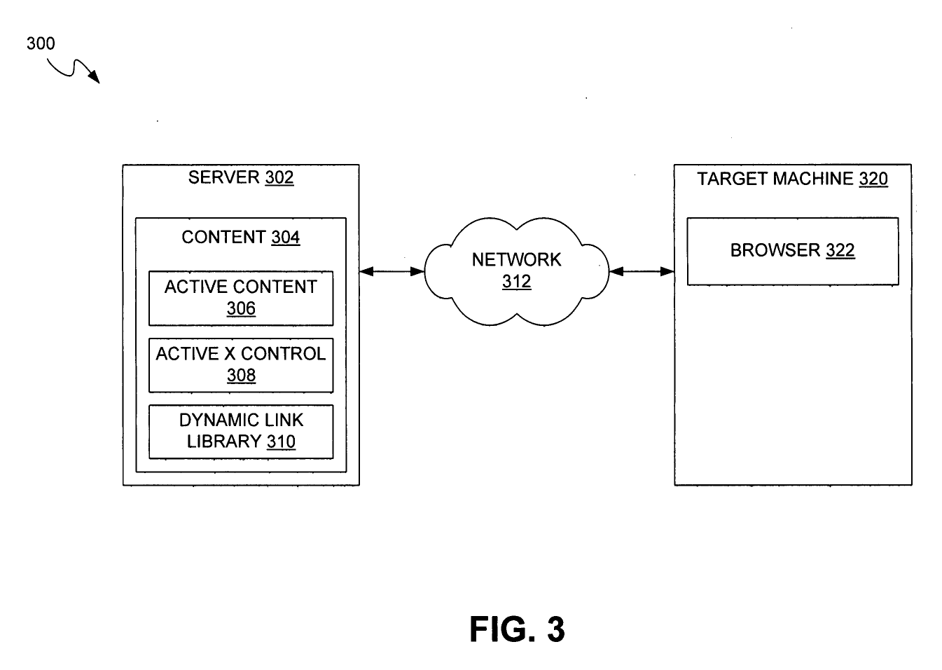

Another embodiment of a system for performing computer diagnostics is depicted schematically in FIG. 3. As shown in FIG. 3, system 300 incorporates a server 302 that includes content 304. Specifically, content 304 includes active content 306 that can facilitate download by a target machine of an active X control 308 and a dynamic link library 310.

Target machine 320 accesses the server via a communication network 312. In particular, the target machine can access the content of the server using a browser 322 that interacts with the server in order to retrieve content.

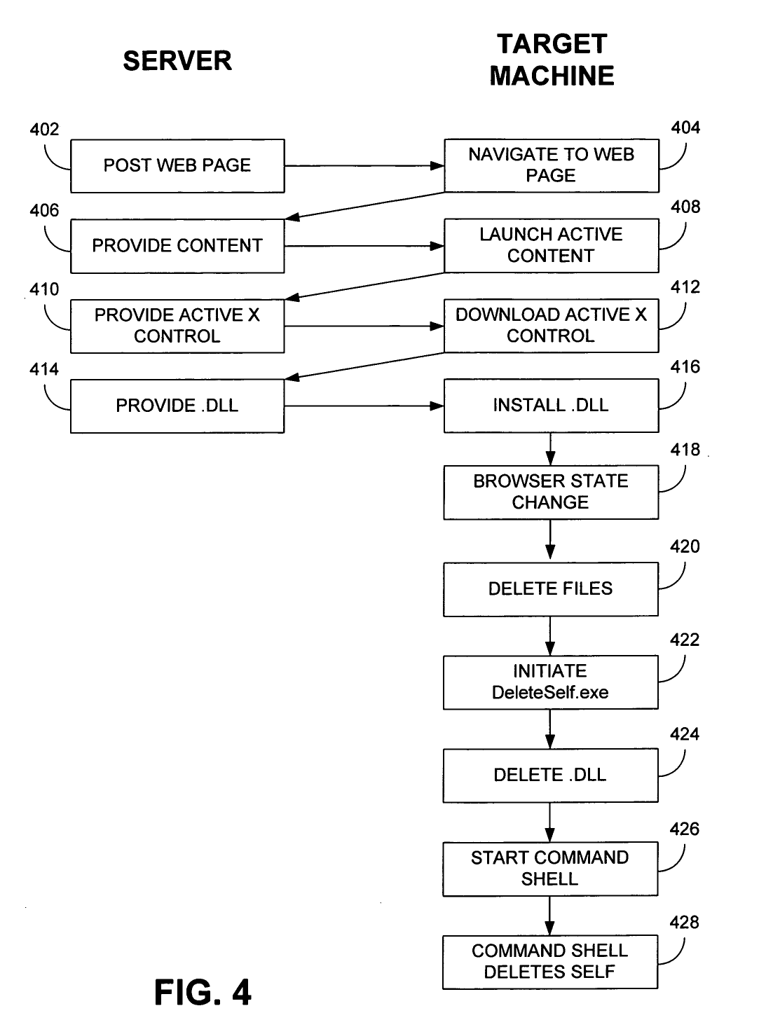

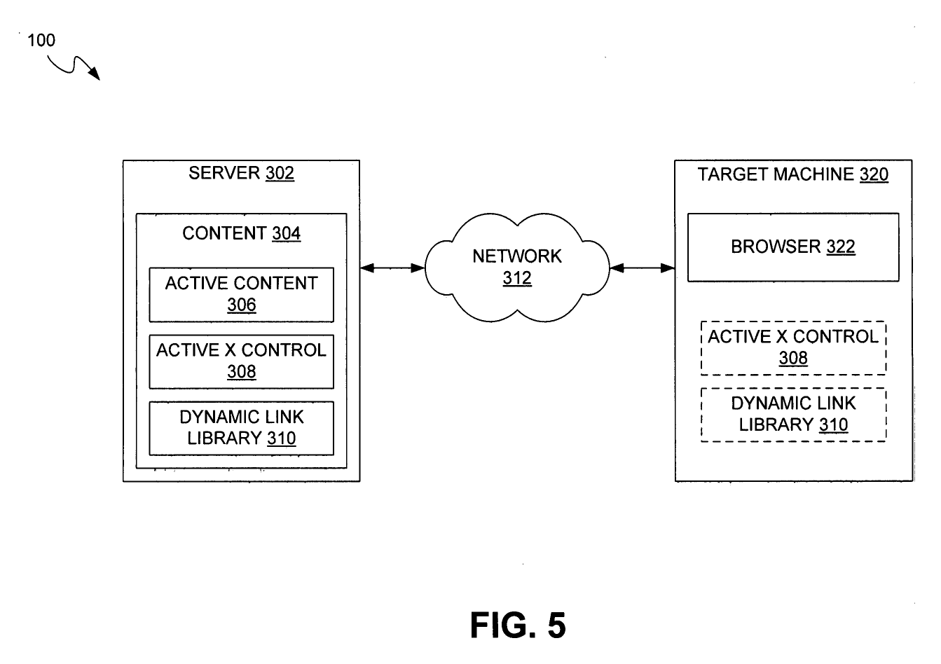

In this regard, functionality of the embodiment of FIG. 3 is depicted in the flowchart of FIG. 4. As shown in FIG. 4, server 302 posts a web page that includes content 304 (block 402). The target machine 320 uses the browser 322 to navigate to the web page (block 404). Responsive to commands received from the browser, the server provides content to the target machine (block 406) including active content 306 that can be launched by the target machine. Responsive to launching of the active content (block 408), the server provides active X control 308 to the target machine (block 410) for installation (block 412). In turn, active X control enables the dynamic link library 310 to be downloaded from the server (block 414) and installed on the target machine (block 416), such as is depicted in FIG. 5. The dynamic link library can be installed as an active X plug-in via the browser that enables support actions to be undertaken on the target machine.

In this regard, various support actions can be launched locally by the user of the target machine and/or remotely by a support provider associated with the server. Such support actions may include identification and/or testing for perceived problems of the target machine, gathering of information and/or updating of the target machine. Once such support actions are complete, completion is identified and used as a stimulus to initiate deletion of the downloaded content from the target machine.

In this embodiment, completion is identified as a change of state of the browser 322 (block 418). By way of example, when the user of the target machine navigates away from the server portal (e.g., the web page) being used for the support actions and/or closes the browser, a change of state can be identified. In this regard, an “OnUnload” browser event can be used to indicate such a state change, thereby initiating a clean up process on the target machine. Other browser events can also be used in addition to or in lieu of an OnUnload event, such as an “OnClick” event.

In this embodiment, the clean up process is initiated by a file that deletes static files (and other objects) associated with the support action. Such files and other objects can include, but are not limited to: any kind of files (e.g *.dll, *.exe, *.ini, *.xml) regardless of location on the target machine; 2) registry keys residing in part of the registry (note that the location may be important because in the Microsoft Vista Operating System only certain programs, e.g., those running with administrator rights, will be allowed access to certain directories and registry keys; 3) any browser helper objects (BHO); and 4) any shortcuts created.

In some embodiments, all such files (with the exception of the file containing the ActiveX) are deleted via script commands from the web page via the ActiveX. After all such files and registry keys are deleted (block 420), the script can start a file called ‘DeleteSelf.exe’ (block 422).

DeleteSelf.exe attempts to delete the file in which the ActiveX is located, in this case, a dynamic link library. In this embodiment, DeleteSelf.exe takes in a command line parameter, which is the fully qualified file name that is to be deleted from the target machine. In this case, the file to be deleted is called Hpisdatamanager.dll that resides in the ‘Windows’ folder on the target machine.

DeleteSelf.exe first verifies that the file name supplied is valid by calling a Windows API that verifies that the file exists. If the file does not exist, DeleteSelf.exe exits without any cleanup. If the file does exist, DeleteSelf.exe attempts to delete the file by calling a Windows API. If the file is not deleted (e.g., which can be determined by testing the return code of the API), the process can delay (e.g., sleep) for a predetermined interval (e.g., 5 seconds), after which the process is repeated. Once the file has been deleted (block 424), which can be determined by monitoring a Boolean operator, DeleteSelf.exe creates a hidden command shell (block 426). Via the command shell, the command ‘del deleteself.exe’ is issued. This command corresponds to an interactive user having started a ‘DOS window’ and issued the command from that window. The del deleteself.exe command removes the file DeleteSelf.exe from the target machine (block 428). Thus, any instructions and/or support tools that were downloaded from the server are no longer present on the target machine.

It should be noted that use of the aforementioned command shell enables all information downloaded from the server to be deleted from the target machine. Therefore, in contrast to conventional methodologies, permanent alteration of the image stored on the target machine is not required in order to facilitate diagnosis. Additionally, although described with respect to the deletion of an ActiveX, various other file types that are currently being accessed can be deleted by such an approach.

Additionally, the target machine itself determines when support actions have ended and facilitates automatic deletion of any associated files. Another perceived advantage involves server side implementation of the diagnostic tools. That is, by posting such information to a web site, for example, access to the aforementioned functionality can be facilitated via use of a browser and associated access to a communication network.

It should be noted that although described with respect to a Windows-based environment, the aforementioned concepts could be implemented in other environments such as Linux-based and Unix-based.

It should be noted that the functionality described above with respect to the disclosed exemplary embodiments can be implemented in hardware and/or software. In this regard, an embodiment of a system for performing computer diagnostics can be implemented by a computer. Generally, in terms of hardware architecture, such a computer can incorporate a processor, memory, and one or more input and/or output (I/O) devices interface(s) that are communicatively coupled via a local interface. The local interface can include, for example but not limited to, one or more buses or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor may be a hardware device for executing software, particularly software stored in memory.

The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the processor. Additionally, the memory includes an operating system, as well as instructions associated with performing various functions, such as those depicted in the exemplary embodiments described above.

One should note that the flowcharts included herein show the functionality and/or operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the functionality disclosed herein, which can include an ordered listing of executable instructions for implementing logical functions (such as depicted in the flowcharts), can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical).

It should be emphasized that many variations and modifications may be made to the above-described embodiments. All such modifications and variations are intended to be included herein within the scope of this disclosure and protected by the following claims.

1. A method for performing computer diagnostics of a target machine, said method comprising:
using a browser of the target machine to communicate with a server;
downloading executable instructions to the target machine from the server;
analyzing the target machine using the executable instructions; and
automatically uninstalling, by the target machine, the executable instructions from the target machine responsive to determining that communication with the server via the browser has changed state.

2. The method of claim 1, wherein the target machine automatically uninstalls the executable instructions responsive to determining that the browser has been closed.

3. The method of claim 1, wherein:
using the browser involves the target machine accessing a web page posted by the server; and
the target machine automatically uninstalls the executable instructions responsive to determining that the browser is no longer accessing the web page.

4. The method of claim 1, wherein automatically uninstalling comprises:
creating a hidden command shell; and
issuing, by the command shell, a command to delete the command shell such that the command shell is deleted from the target machine.

5. The method of claim 1, wherein:
the executable instructions are second executable instructions; and
the method further comprises installing first executable instructions at the target machine, the first executable instructions being operative to enable downloading of the second executable instructions.

6. The method of claim 5, wherein the second executable instructions comprise Active X control.

7. The method of claim 6, further comprising providing, by the server, active content for enabling download of the Active X control by the target machine.

8. The method of claim 1, wherein analyzing comprises interaction by a support provider associated with the server.

9. The method of claim 1, wherein analyzing comprises interaction by a user of the target machine.

10. The method of claim 1, further comprising correcting an analyzed problem of the target machine.

11. A method for performing computer diagnostics of a target machine, said method comprising:
providing access to a server, the server being accessible via a browser of the target machine; and
providing, from the server to the target machine, software to enable analyzing of the target machine, the software being configured for automatic uninstallation from the target machine such that the software causes the target machine to delete the software from the target machine after use.

12. The method of claim 11, wherein the software is deleted from the target machine responsive to communication between with the server and the target machine changing state.

13. The method of claim 12, wherein:
the server posts a web page accessible by the browser of the target machine; and
the software causes the target machine automatically uninstalls the software responsive to determining that the browser is no longer accessing the web page.

14. A system for performing computer diagnostics comprising:
a server operative to provide access to content via a browser of a target machine, the content comprising software to enable analyzing of the target machine, the software being configured for automatic uninstallation from the target machine such that the software causes the target machine to delete the software from the target machine.

15. The system of claim 14, wherein:
the software is second software; and
the server is further configured to provide first software to the target machine, the first software being operative to enable downloading of the second software from the server to the target machine.

16. The system of claim 15, wherein the second software comprises Active X control.

17. A system for performing computer diagnostics comprising:
a target machine having a browser and executable instructions;
the browser being operative to communicate with a server;
the executable instructions being configured to analyze the target machine;
wherein the target machine automatically uninstalls the executable instructions responsive to determining that communication with the server via the browser has changed state.

18. The system of claim 17, wherein the target machine automatically uninstalls the executable instructions responsive to determining that the browser has been closed.

19. The system of claim 17, wherein:
the browser is operative to access a web page posted by the server; and
the target machine automatically uninstalls the executable instructions responsive to determining that the browser is no longer accessing the web page.

20. The system of claim 17, wherein, responsive to determining that communication with the server via the browser has changed state, the target machine is operative to create a hidden command shell and issue, via the command shell, a command to delete the command shell such that the command shell is deleted from the target machine.
